(19) United States
(12) Patent Application Publication
(10) Pub. No.: US 2014/0337129 A1
(43) Pub. Date: Nov. 13, 2014

(54) Content Recommendation Based on Uniqueness of Individuals in Target Audience

(71) Applicant: INTERNATIONAL BUSINESS MACHINES CORPORATION, Armonk, NY (US)

(72) Inventors: DAVID CARMEL, Haifa (IL); IRIS EIRON, Ein Ayyala (IL); YOSI MASS, Ramat Gan (IL); HAGGAI ROITMAN, Yoknea'm Elit (IL)

(73) Assignee: International Business Machines Corporation, Armonk, NY (US)

(21) Appl. No.: 13/888,394

(22) Filed: May 7, 2013

(51) Int. Cl. G06Q 30/02

(52) U.S. Cl. CPC G06Q 30/0255
USPC 705/14.53

(57) ABSTRACT

Machines, systems and methods for promoting content, the method comprising monitoring activities of one or more individuals to determine whether at least a first individual from among said one or more individuals has a unique preference for one or more features of an item; and recommending promoting, to the first individual, one or more items relevant to the one or more features, based on the first individual's estimated uniqueness.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to content recommendation and, more particularly, to content recommendation based on individualized uniqueness of a target audience.

### BACKGROUND

Referring to FIG. 1, an operating environment 100 is illustrated in which profiling technology 114 and a recommendation mechanism are used to deliver the most suitable content 140 to an individual 124 in an audience 120, where individual 124 has interests or preferences for receiving certain types of content. Profiling technology 114 and the recommendation mechanism 112 may be implemented on one or more computing systems 120 and the content recommendation may be achieved over a communications network 140.

Depending on implementation, the filtering may be either collaborative or content-based, or based on a combination of the two. Unfortunately, not many of the currently available methods take into consideration the uniqueness of individual preferences, in a meaningful way, for the purpose of determining the kind of content that is to be delivered to a particular individual in a target audience.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, machines, systems and methods for promoting content are provided. The method comprises monitoring activities of one or more individuals to determine whether at least a first individual from among said one or more individuals has a unique preference for one or more features of an item; and recommending promoting, to the first individual, one or more items relevant to the one or more features, based on the first individual's estimated uniqueness.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates an example operating environment in accordance with one or more embodiments, wherein profiling and recommendation methods are used to deliver content to an individual.

FIG. 2 is an example flow diagram of a method of selecting content to be delivered to an individual according to his uniqueness, in accordance with one embodiment.

FIG. 3 is an example flow diagram of a method of delivering content to an individual according to the level of divergence of the individual's interest from the average individual, in accordance with one embodiment.

FIGS. 4A and 4B are block diagrams of hardware and software environments in which the disclosed systems and methods may operate, in accordance with one or more embodiments.

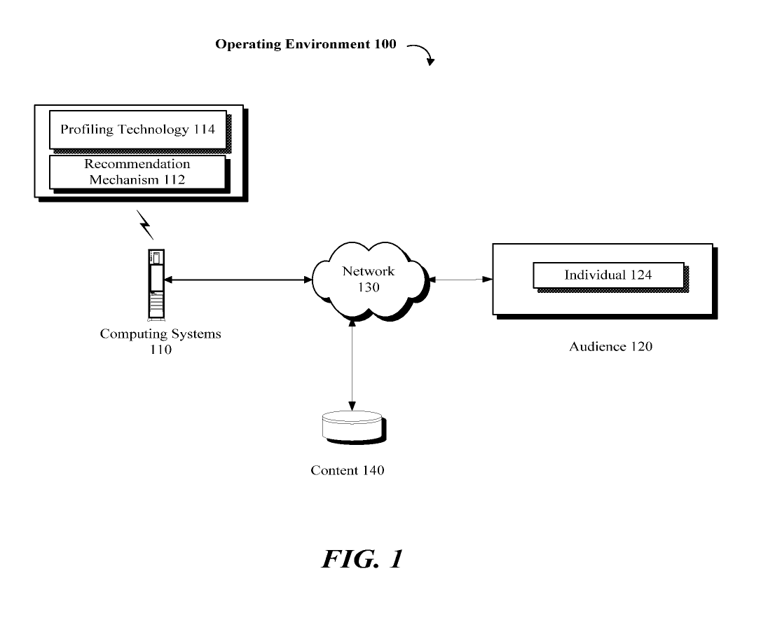

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

Systems and methods are provided to promote one or more items to one or more individuals based on the degree with which an individual's interest in (or preference for) certain items identifies him as unique in comparison to other individuals in an audience. In the following, the terms item or content may be used interchangeable. An item or content, more generally and without limitation, may refer to data, documents, advertisements, audio/video data or events of any kind, including but not limited to consumable digital items such as digital movies, books, etc.

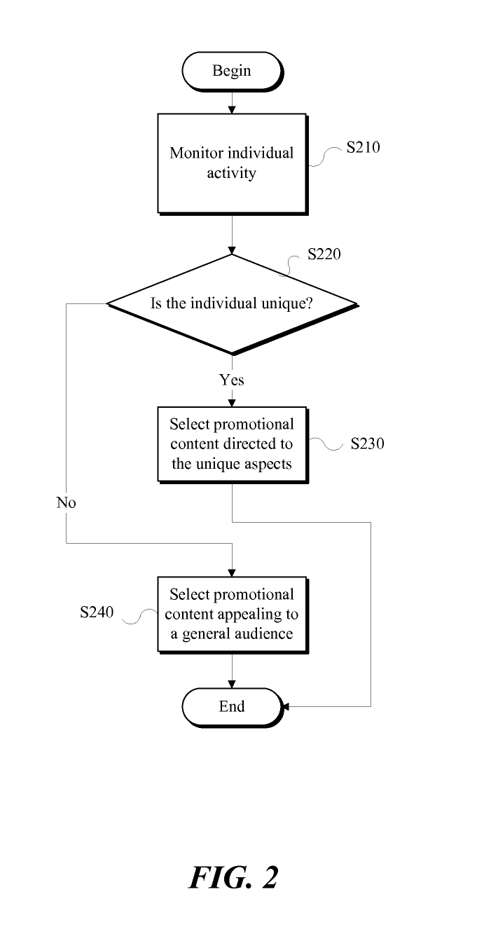

Referring to FIG. 2, an individual may be tracked and profiled according to his online or offline activity (S210). An analysis of the individuals profile or activity may be done to determine whether an individual's activities or profile would identify him as unique in one or more areas (S220). If an individual is determined to be unique based on such analysis, then content that is selected for promotion to the unique individual will be related to the unique aspects of the individual (S230). If the individual is determined to be a person of average interest, then the promotional content is selected from type of content that appeals to a general audience (S240), optionally without considering any unique aspects of the individual.

In one embodiment, an individual's preferences may be determined based on the individual's rating for a collection of content or items (i). An item may have a set of features (f), and a feature may or may not have a value (V). For an item's features, a binary vector may be implemented, where the number of entries in the vector corresponds to the number of features possible for an item. If the item has specific feature values, the respective vector entry may be assigned a first value (e.g., 1), otherwise a second value (e.g., 0) may be assigned to indicate that a particular feature is not present in for that item. If an individual is interested in a feature, then a third value (e.g., a real number) may be associated with the feature to indicate the relative level of individual's interest in the feature. For example, the value of 10 may indicate a high interest in a feature, where the scale for level of interest in the feature is from 0 to 10.

In one implementation, the above interest level or an individual preferences in a plurality of features for a collection of items may be represented in the form of a vector of weights, as provided in the following formula, where f.v represents a feature value for an item “i” and “w” is the weight assigned to that value.

$${\vec{w}}_{f}^{u} = ( {w}_{f . {υ}_{1}}^{u} , {w}_{f . {υ}_{2}}^{u} , … , {w}_{f . {υ}_{\vert {V}_{f} \vert}}^{u} )$$

Once an individual's preferences (e.g., calculated as weight) for one or more features for the collection of items are determined, then the determined preferences are compared to the preferences of a group of other individuals (e.g., a generic group of individuals, or an average individual in the group). In one example, a weighting mechanism may be utilized to determine the degree with which the preferences of a particular individual for a topic of interest diverge from the preferences of an individual (e.g., an average individual) in the selected group.

In one implementation, if the calculated weight is above a certain threshold (e.g., w>0), then it may be determined that the subject individual has a high level of interest in a topic. If the calculated weight is below a threshold (e.g., w<0), it reflects a low level of interest in the topic. If the weight is approximately equal to a threshold (e.g., w=0), then it reflects an average level of interest in the topic.

The following formulas may be used, in one example embodiment, to determine an individual's level of interest in an item, where Ui is the set of users who rates an item i (or in general, users that are associated with an item i), and r_îu is a user rating given to an item i.
Formula A: to determine the probability that an average individual in the group prefers items that have a feature with a certain value (e.g., an item may be a movie, and a value may be an actor “John Doe” starring in the movie):

$${P}_{f . υ} {=}^{Δ} \frac{{\sum }_{i ∈ {I}_{f . υ}} log ( {\sum }_{u ∈ {U}_{i}} {r}_{i}^{u} )}{{\sum }_{f . {υ}^{′} ∈ {V}_{f}} {\sum }_{i ∈ {I}_{f . {υ}^{′}}} log ( {\sum }_{u ∈ {U}_{i}} {r}_{i}^{u} )}$$

Formula B: to determine the probability that the subject individual prefers items that have a feature with a certain value:

$${P}_{f , υ}^{u} {=}^{Δ} ( 1 - λ ) \frac{{\sum }_{i ∈ {I}_{f . υ}^{u}} {r}_{i}^{u}}{{\sum }_{f . {υ}^{′} ∈ {V}_{f}} {\sum }_{i ∈ {I}_{f . {υ}^{′}}^{u}} {r}_{i}^{u}} + λ {P}_{f . υ}$$

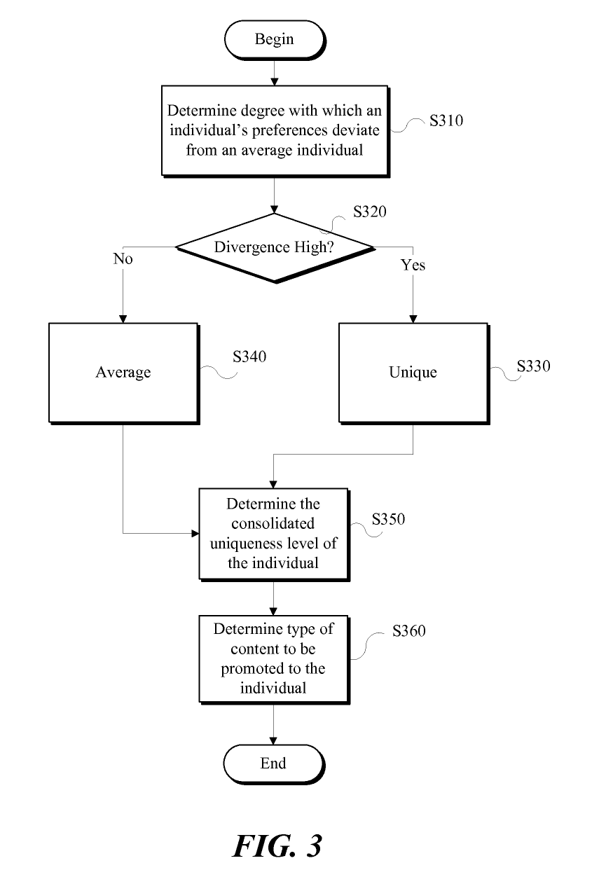

Referring to FIG. 3, the above formulas may be utilized to determine the degree with which the subject individual's preferences deviate from the average individual (or an average audience) preferences, in a particular feature (S310). If a high level of divergence is detected (S320), that would identify an individual as unique (S330), meaning that he should be considered as part of the average audience with respect to a feature. In contrast, if a low level of divergence is detected, then that would qualify an individual as average (i.e., not unique) with respect to the feature (S340).

The following formula may be used, in an example embodiment, to determine the marginal contribution of a feature value to the divergence of a subject individual's preferences from that of an average individual:

$${w}_{f . υ}^{u} {=}^{Δ} {P}_{f . υ}^{u} log \frac{{P}_{f . υ}^{u}}{{P}_{f . υ}}$$

Once the subject individual's uniqueness with respect to a plurality of separate features is determined, the results may be used to determine the consolidated uniqueness level of the individual for the overall set of features (S350). In one example, the overall uniqueness of the subject individual may be calculated by taking into account the probability density function of an individual's preferences over the feature value weights according to the following formula:

$${β}_{f}^{u} = \frac{\# \{ f . υ \vert f . υ ∈ {V}_{f} \vert {w}_{f . υ}^{u} \vert \leq ε \}}{\vert {V}_{f} \vert}$$

Once the overall uniqueness of an individual is determined, the results may be utilized to determine the type of content that is to be promoted to the individual (S360). Depending on implementation, one or more different strategies may be used to determine the type of content that is to be promoted. In the following, three example strategies are provided.

In one example embodiment, a personalized item scoring formula provided below may be used, so that content that is related to identified features of interest may be promoted to an individual identified as having a unique interest in the feature. It is noteworthy that feature values with positive weights (i.e., indicating high user interest) have a higher likelihood of being promoted, while those with negative weights (i.e., indicating low user interest) have a lower likelihood of being promoted.

$${score}_{PERS} ( i , u ) = \frac{1}{n} {\sum }_{f ∈ F} \frac{{\vec{i}}_{f} \cdot {\vec{w}}_{f}^{u}}{‖ {\vec{i}}_{f} ‖}$$

In certain example embodiments, a popularity item scoring formula provided below may be used, so that content that is popular and is generally of common interest to the average audience is promoted to an individual identified as having an average interest in the feature, where U_k̂u is the set of K most similar users based on user's ratings (e.g., using Pearson correlation or any other similarity method used in collaborative filtering).

$${score}_{POP} ( i , u ) = \frac{{\sum }_{{u}^{′} ∈ {U}_{i} ⋂ {U}_{k}^{u}} {r}_{i}^{{u}^{′}}}{{\sum }_{{i}^{′} ∈ I} {\sum }_{{u}^{′} ∈ {U}_{{i}^{′}} ⋂ {U}_{k}^{{u}^{′}}} {r}_{{i}^{′}}^{{u}^{′}}}$$

In some embodiments, a hybrid strategy using a combined item scoring formula as provided below may be used. The combined scoring formula is an amalgam of the personalized item scoring and popularity item scoring formulas provided above and utilizes an individual's uniqueness level to reach a common ground between the above two formulas, where Betâu is the average user uniqueness over all possible features.

score_{POPERS}(i, u)=β^{u}score_{POP}(, u)+(1−β^{u})score_{PERS}(i, u)

In summary, a framework for modeling the uniqueness of user preferences from among other users in an audience is provided. User uniqueness is determined by learning to what extent the user's preferences deviate from those of an average user. Depending on implementation, alternative strategies may be utilized based on user uniqueness assumptions. In one embodiment, items that satisfy the user unique preferences are recommended for delivery. In another embodiment, assuming that the user has no unique preferences, popular items that are likely to satisfy the preferences of an average user are recommended for delivery. In a hybrid embodiment, recognizing that user preferences may lie in between two extremes, a user's uniqueness level is utilized.

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

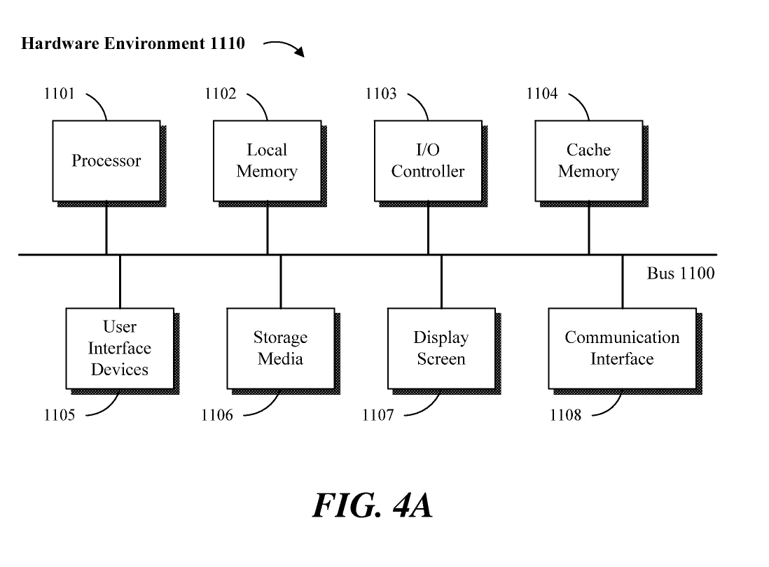

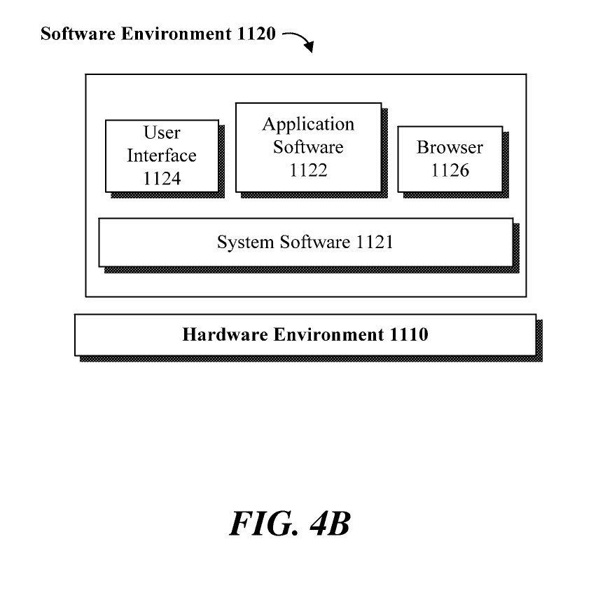

Referring to FIGS. 4A and 4B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 4A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 4B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method for promoting content, the method comprising:
monitoring activities of one or more individuals to determine whether at least a first individual from among said one or more individuals has a unique preference for one or more features of an item; and
recommending promoting, to the first individual, one or more items relevant to the one or more features, based on the first individual's estimated uniqueness.

2. The method of claim 1, wherein in response to determining that the first individual lacks a unique preference for one or more features of an item, items that are of general interest to an average group of individuals are recommended to the first individual.

3. The method of claim 1, wherein it is determined that the first individual has a unique preference for one or more features of an item, in response to determining that the first individual's interest in said one or more features diverges from an average level of interest in said one or more feature beyond a first threshold.

4. The method of claim 1, wherein it is determined that the first individual does not have a unique preference for one or more features of an item, in response to determining that the first individual's interest in said one or more features diverges from an average level of interest in said one or more feature less than a first threshold.

5. The method of claim 4, wherein results of the first individual's uniqueness with respect to a plurality of separate features is used to determine a consolidated uniqueness level of the individual for said one or more features.

6. The method of claim 5, wherein the consolidated uniqueness of the first individual is calculated by taking into account a probability density function of the first individual's preferences.

7. The method of claim 6, wherein results of the consolidated uniqueness of the first individual may be used to determine type of content that is to be promoted to the first individual.

8. The method of claim 7, wherein one or more different strategies are used to determine the type of content that is to be promoted, wherein a first recommendation strategy involves promoting content that is related to identified features of interest in which the first user is determined to have a unique interest.

9. The method of claim 8, wherein a second recommendation strategy involves using a popularity item scoring formula to promote content that is of common interest to an average audience is promoted to the first individual, if the first individual is identified as having an average interest in the one or more features.

10. The method of claim 9, wherein a hybrid strategy using a combined item scoring formula is used as an amalgam of the first and second recommendation strategies, using the first individual's uniqueness level to reach a common ground between the first and second recommendation strategies.

11. A system for promoting content, the system comprising:
a logic unit for monitoring activities of one or more individuals to determine whether at least a first individual from among said one or more individuals has a unique preference for one or more features of an item; and
a logic unit for recommending promoting, to the first individual, one or more items relevant to the one or more features, based on the first individual's estimated uniqueness.

12. The system of claim 11, wherein in response to determining that the first individual lacks a unique preference for one or more features of an item, items that are of general interest to an average group of individuals are recommended to the first individual.

13. The system of claim 11, wherein it is determined that the first individual has a unique preference for one or more features of an item, in response to determining that the first individual's interest in said one or more features diverges from an average level of interest in said one or more feature beyond a first threshold.

14. The system of claim 11, wherein it is determined that the first individual does not have a unique preference for one or more features of an item, in response to determining that the first individual's interest in said one or more features diverges from an average level of interest in said one or more feature less than a first threshold.

15. The system of claim 14, wherein results of the first individual's uniqueness with respect to a plurality of separate features is used to determine a consolidated uniqueness level of the individual for said one or more features.

16. A computer program product comprising a computer readable storage medium having a computer readable program, wherein the computer readable program when executed on a computer causes the computer to:
monitor activities of one or more individuals to determine whether at least a first individual from among said one or more individuals has a unique preference for one or more features of an item; and
recommend promoting, to the first individual, one or more items relevant to the one or more features, based on the first individual's estimated uniqueness.

17. The computer program product of claim 16, wherein in response to determining that the first individual lacks a unique preference for one or more features of an item, items that are of general interest to an average group of individuals are recommended to the first individual.

18. The computer program product of claim 16, wherein it is determined that the first individual has a unique preference for one or more features of an item, in response to determining that the first individual's interest in said one or more features diverges from an average level of interest in said one or more feature beyond a first threshold.

19. The computer program product of claim 16, wherein it is determined that the first individual does not have a unique preference for one or more features of an item, in response to determining that the first individual's interest in said one or more features diverges from an average level of interest in said one or more feature less than a first threshold.

20. The computer program product of claim 19, wherein results of the first individual's uniqueness with respect to a plurality of separate features is used to determine a consolidated uniqueness level of the individual for said one or more features.
